(19) United States
(12) Patent Application Publication
(10) Pub. No.: US 2005/0165207 A1
(43) Pub. Date: Jul. 28, 2005

(54) Polyester molding composition and process for its preparartion

(75) Inventors: Parminder Agarwal, Evansville, IN (US); Peter H. Th. Vollenberg, Evansville, IN (US); Kyle P. Starkey, Evansville, IN (US); Kenneth Frederick Miller, Mt. Vernon, IN (US)

Correspondence Address: GEAM - O8CV - CPP;IP LEGAL, ONE PLASTICS AVENUE, PITTSFIELD, MA, 01201-3697, US

(73) Assignee: General Electric Company

(21) Appl. No.: 11/021,463

(22) Filed: Dec. 22, 2004

Related U.S. Application Data
(60) Provisional application No. 60/533,609, filed on Dec. 31, 2003.

(51) Int. Cl. C08L 1/00

(52) U.S. Cl. 528/272

(57) ABSTRACT

A novel process produces a novel polyester resin composition comprised of modified polyester having increased acid end groups that are chemically reacted with a polyfunctional carboxy reactive material. The resulting polyester has enhanced chemical resistance and/or improved melt viscosity. Blends of the modified polyester with polycarbonate can be made and are characterized by improved chemical resistance and/or melt viscosity.

### CROSS REFERENCE TO RELATED APPLICATIONS

This application claims priority to U.S. Provisional Application Ser. No. 60/533609 filed on Dec. 31, 2003, which is incorporated herein by reference in its entirety.

### FIELD OF THE INVENTION

The invention relates to compositions comprising polyester resins and a process for their preparation.

### BACKGROUND OF THE INVENTION

Polyester compositions including blends of polyester resins with other polymers, like polycarbonate, are desirable for many applications. Useful compositions include both transparent and opaque alloys of polyesters and polycarbonate and can be found in a broad range of automotive, consumer, electronic, and medical applications, to name a few. It is desirable that these compositions have properties like increased chemical resistance and melt viscosity to sustain their performance in their end use environment.

Some examples of enhancing the performance of polyester-polycarbonate blends are described in the following patents. U.S. Pat. No. 5,087,665 Chung et al. disclose a method of improving the hydrostabilty of blends of polycarbonate and polyester i.e. polyethylene terephthalate, by adding polyethylene to the blends. U.S. Pat. Nos. 5,411,999 and 5,596,049 to Robert R. Gallucci et al. describe the use of epoxy based material in conjugation with the catalyst quenchers to promote hydrostabilty. U.S. Pat. No. 5,300,546 to Walsh relates to polyester compositions with mineral fillers giving a ceramic feel which have improved hydrostabilty and melt viscosity stability. European Patent Specifications EP 0 273 149 and EP 0 497 818, both having Minnick as an inventor, describe additions of epoxy oligomeric materials to certain polyesters, however, the focus of their study was neither better chemical resistance nor improved melt viscosity, but only thermal stability and specifically in glass reinforced and/or flame-retarded polyester formulations.

It is desirable to further improve upon the capability of polyester compositions and blends containing polycarbonate by introducing changes into the polyester resin that render it capable of improved performance for example improved melt viscosity and/or better resistance to chemicals encountered by a product in its typical use environment.

Improved melt viscosity is desirable in certain applications, such as in extrusion blow molding process. As the melt viscosity improves, the parison formed in this process is more stable.

### SUMMARY OF THE INVENTION

According to an embodiment, a polyester resin is modified to increase the acid end groups of the polyester resin and to utilize this increased acid end group content to modify the performance of the polyester resin and its blends. It is noted that the acid end groups are further reacted with a “polyfunctional carboxy reactive material”. These are exemplified throughout the summary of the invention and thereafter as a “material with multiple epoxy groups”, whereas any polyfunctional carboxy reactive material can be used. These are exemplified under the reactive moieties section of the specification.

According to an embodiment, a polyester resin of modified acid end group content is treated with other reactive moieties, such as a material with multiple epoxy groups, to produce polyester containing materials of enhanced performance with respect to chemical resistance and/or improved melt viscosity.

The results obtained are surprising in that the acid modified polyester has a lowered molecular weight and performance characteristics. However the resin compositions containing this modified polyester that has subsequently been treated with a polyfunctional carboxy reactive material result in resin compositions that have improved performance than the resin compositions obtained with similar levels of the starting polyester.

According to an embodiment, a polyester resin composition arises from a chemically modified polyester resin having increased acid end groups chemically reacted with a material with multiple epoxy groups for enhancing the chemical resistance of the resulting polyester.

According to another embodiment, a polyester resin having acid end groups is treated with an acid enhancing additive for producing a modified polyester resin having an increased number of acid end groups. A material containing multiple epoxy groups is chemically reacted with at least a portion of the end groups in the modified polyester resin for increasing the chemical resistance and/or improved melt viscosity as measure by the melt volume rate (MVR) of the resulting polyester.

According to an embodiment, a simple process for chemically modifying a polymer such as polyester in an extruder and to subsequently react that modified polymer in an extruder to produce materials with enhanced performance is obtained.

According to an embodiment, a polycarbonate/polyester resin molding composition having enhanced chemical resistance and/or improved melt viscosity is derived from a blend of a polycarbonate resin, a polyester resin and a material with multiple epoxy groups wherein the polyester resin is or has been treated with an acid enhancing additive for producing a modified polyester resin having an increased number of acid end groups.

According to an embodiment, a process for producing a polycarbonate/polyester resin molding composition having enhanced chemical resistance and/or improved melt viscosity, as measured by melt volume rate (MVR) comprising mixing polycarbonate resin, a polyester resin having acid end groups, and a material with multiple epoxy groups, and treating the polyester resin with an acid enhancing additive for producing a modified polyester resin having an increased number of acid end groups.

According to an embodiment, the acid enhancing additive can be added prior to or during the treatment process that produces the modified polyester resin having an increased number of acid end groups. It is contemplated that multiple treatment steps can be utilized to increase the number of acid end groups that would be reacted with the material with multiple epoxy groups. In a similar fashion, the material containing multiple epoxy groups can be added concomitantly with or subsequent to the formation of an increased number of acid end groups.

According to an embodiment, the treatment processes referred to above can be any thermal or similar energetic treatment step that produces the desired reaction between the reactive additive and the polyester resin. Examples of typical thermal treatment processes used in the art include, but are not limited to melt mixing, melt extrusion, dry blending followed by oven treatment, solid-state polymerization, reactive injection molding, etc. These are included only as reference and are not intended to limit the scope of the embodiment.

According to an embodiment, the modified polyester resin is treated with the material containing multiple epoxy groups for enhancing the chemical resistance of the said polycarbonate/polyester resin blend.

According to an embodiment, the material with multiple epoxy groups can be sufficiently reactive in the absence of a catalyst to enhance the chemical resistance and/or improve the melt viscosity of the resulting composition. If a faster process is desired, an appropriate catalyst such as sodium stearate can be used.

### BRIEF DESCRIPTION OF THE DRAWINGS

FIG. 1 illustrates tensile bars after exposure to Coppertone® sunblock lotion, SPF30 for two days under 1% strain. FIG. 2 illustrates tensile bars after exposure to Eucalyptus Essential Oil from Humco for 2 days at 0.5% strain.

### DETAILED DESCRIPTION OF PREFERRED EMBODIMENTS

Acid End Group Enhancement

The polyester resin is treated with an acid end group enhancing additive for producing a modified polyester resin having an increased number of acid end groups. In order to observe the increase in the chemical resistance of the final polymer or polymer blend, the acid enhancing additive acts to increase the number of acid end groups of the polyester. Suitable acids may react with an alcohol end group of the polyester to form an acid end group. The acid additives may also do ester-acid exchange randomly within the polymer chain to produce two acid terminated polymer ends. According to a preferred treatment, the polyester is treated with a suitable acid so as to result in higher acid end groups. Acids include polyfunctional organic acids or materials that can form polyfunctional acid upon hydrolysis. Some preferred polyfunctional organic acids include terephthalic acid (TPA), isophthalic acid, trimellitic acid and other functionalized aromatic acids. Materials that form carboxylic acids upon hydrolysis, such as anhydrides may also be used. Some preferred anhydrides include trimellitic anhydride and pyromellitic dianhydride.

Reactive Moieties

Any polyfunctional carboxy reactive material can be used for the treatment of the acid modified polyester or polyester blends. These can be either polymeric or non-polymeric. Examples of carboxy reactive groups include epoxides, carbodiimides, orthoesters, oxazolines, oxiranes, aziridines, and anhydrides. The carboxy reactive material can also include other functionalities that are either reactive or non-reactive under the described processing conditions. Non-limiting examples of reactive moieties include reactive silicone containing materials, for example epoxy modified silicone monomers and polymeric materials. If desired, a catalyst or co-catalyst system can be used to accelerate the reaction between the polyfunctional carboxy-reactive material and the modified polyester. The term “poly” means at least two carboxy reactive groups.

Particularly useful reactive moieties for treatment of the modified polyester resins or blends include materials with more than one reactive epoxy group. The polyfunctional epoxy compound may contain aromatic and/or aliphatic residues. Typical examples used in the art include 3,4-epoxycyclohexylmethyl-3,4-epoxycyclohexanecarboxylate, epoxy novolac resins, epoxidized vegetable (soybean, linseed) oils, and styrene-acrylic copolymers containing pendant glycidyl groups.

Preferred materials with multiple epoxy groups are styrene-acrylic copolymers and oligomers containing glycidyl groups incorporated as side chains. Several useful examples are described in the International Patent Application WO 03/066704 A1 assigned to Johnson Polymer, LLC, incorporated herewith. These materials are based on oligomers with styrene and acrylate building blocks that have desirable glycidyl groups incorporated as side chains. A high number of epoxy groups per oligomer chain is desired, at least about 10, preferably greater than about 15, and more preferably greater than about 20. These polymeric materials generally have a molecular weight greater than about 3000, preferably greater than about 4000, and more preferably greater than about 6000. These are commercially available from Johnson Polymer, LLC under the Joncryl® trade name. Preferably, Joncryl® ADR 4368 is used.

Polyester

The starting polyester resin components typically comprises structural units of the following formula:

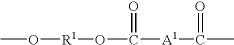

wherein each R¹ is independently a divalent aliphatic, alicyclic or aromatic hydrocarbon or polyoxyalkylene radical, or mixtures thereof and each A¹ is independently a divalent aliphatic, alicyclic or aromatic radical, or mixtures thereof. Examples of suitable polyesters containing the structure of the above formula are poly(alkylene dicarboxylates), liquid crystalline polyesters, and polyester copolymers. It is also possible to use branched polyester in which a branching agent, for example, a glycol having three or more hydroxyl groups or a trifunctional or multifunctional carboxylic acid has been incorporated. Furthermore, it is sometimes desirable to have various concentrations of acid and hydroxyl end groups on the polyester, depending on the ultimate end-use of the composition.

The R¹ radical may be, for example, a C₂₋₁₂ alkylene radical, a C₆₋₁₂ alicyclic radical, a C₆₋₂₀ aromatic radical or a polyoxyalkylene radical in which the alkylene groups contain about 2-6 and most often 2 or 4 carbon atoms. The A¹ radical in the above formula is most often p- or m-phenylene, a cycloaliphatic or a mixture thereof. This class of polyester includes the poly(alkylene terephthalates) and the polyarylates. Such polyesters are known in the art as illustrated by the following patents, which are incorporated herein by reference.

| | | | |
|---|---|---|---|
| 2,465,319 | 2,720,502 | 2,727,881 | 2,822,348 |
| 3,047,539 | 3,671,487 | 3,953,394 | 4,128,526 |

Examples of aromatic dicarboxylic acids represented by the dicarboxylated residue A¹ are isophthalic or terephlthalic acid, 1,2-di(p-carboxyphenyl)ethane, 4,4′-dicarboxydiphenyl ether, 4,4′ bisbenzoic acid and mixtures thereof. Acids containing fused rings can also be present, such as in 1,4- 1,5- 2,7- or 2,6- naphthalenedicarboxylic acids. The preferred dicarboxylic acids are terephthalic acid, isophthalic acid, naphthalene dicarboxylic acid, cyclohexane dicarboxylic acid or mixtures thereof.

Polyesters include poly(ethylene terephthalate) (“PET”), and poly(1,4-butylene terephthalate), (“PBT”), poly(ethylene naphthanoate) (“PEN”), poly(butylene naphthanoate), (“PBN”) and poly(propylene terephthalate) (“PPT”), and mixtures thereof.

Polyesters also include resins comprised of terephthalic acid, 1,4-cyclohexanedimethanol and ethylene glycol for example PCTG, PETG, PCTA, PCT resins which are available from the Eastman Chemical Company.

Polyesters also include PCCD referred to above is poly(1,4-cyclohexylenedimethylene 1,4- cyclohexanedicarboxylate) also sometimes referred to as poly(1,4-cyclohexene-dimethanol-1,4-dicarboxylate) which has recurring units of the formula: 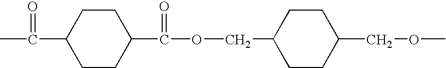
and modifications of PCCD with various diols or polytetrahydrofuran co-monomers.

Polyesters may include minor amounts, e.g., from about 0.5 to about 5 percent by weight, of units derived from various aliphatic acid and/or aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

Starting polyesters in this process can have an intrinsic viscosity of from about 0.4 to about 2.0 dl/g as measured in a 60:40 phenol/tetrachloroethane mixture or similar solvent at 23°-30° C.

Recycled polyesters and blends of recycled polyesters with virgin polyester can be used.

Co-polyester-polycarbonates, can also be used.

Polycarbonate

The polyester resin component can be blended with a polycarbonate resin. Polycarbonate resins are generally aromatic polycarbonate resins. Typically these are prepared by reacting a dihydric phenol with a carbonate precursor, such as phosgene, a haloformate or a carbonate ester. Generally speaking, such carbonate polymers may be typified as possessing recurring structural units of the formula

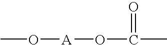

wherein A is a divalent aromatic radical of the dihydric phenol employed in the polymer producing reaction. Typically, the carbonate polymers used to provide the resinous mixtures of the invention have an intrinsic viscosity (as measured in methylene chloride at 25° C.) ranging from about 0.30 to about 1.00 dl/g. The dihydric phenol which may be employed to provide such aromatic carbonate polymers are mononuclear or polynuclear aromatic compounds, containing as functional groups two hydroxy radicals, each of which is attached directly to a carbon atom of an aromatic nucleus. Typical dihydric phenols are: 2,2-bis(4-hydroxyphenyl) propane; hydroquinone; resorcinol; 2,2-bis(4-hydroxyphenyl) pentane; 2,4′-(dihydroxydiphenyl) methane; bis(2 hydroxyphenyl) methane; bis(4 -hydroxyphenyl) methane; 1,1-bis(4-hydroxyphenyl)-3,3,5-trimethylcyclohexane; fluorenone bisphenol, 1,1-bis(4-hydroxyphenyl) ethane; 3,3-bis(4-hydroxyphenyl) pentane; 2,2-dihydroxydiphenyl; 2,6-dihydroxynaphthalene; bis(4-hydroxydiphenyl)sulfone; bis(3,5-diethyl-4-hydroxyphenyl)sulfone; 2,2-bis(3,5-dimethyl-4-hydroxyphenyl)propane; 2,4′-dihydroxydiphenyl sulfone; 5′-chloro-2,4′-dihydroxydiphenyl sulfone; bis-(4-hydroxyphenyl)diphenyl sulfone; 4,4′-dihydroxydiphenyl ether; 4,4′-dihydroxy-3,3′-dichlorodiphenyl ether; 4,4-dihydroxy-2,5-dihydroxydiphenyl ether; and the like.

Other dihydric phenols used in the preparation of the above polycarbonates are disclosed in U.S. Pat Nos. 2,999,835; 3,038,365; 3,334,154; and 4,131,575.

Aromatic polycarbonates can be manufactured by known processes; such as, for example and as mentioned above, by reacting a dihydric phenol with a carbonate precursor, such as phosgene, in accordance with methods set forth in the above-cited literature and in U.S. Pat. No. 4,123,436, or by transesterification processes such as are disclosed in U.S. Pat. No. 3,153,008, as well as other processes known to those skilled in the art.

It is also possible to employ two or more different dihydric phenols or a copolymer of a dihydric phenol with a glycol or with a hydroxy- or acid-terminated polyester or with a dibasic acid in the event a carbonate copolymer or interpolymer rather than a homopolymer is desired for use in the preparation of the polycarbonate mixtures of the invention. Branched polycarbonates are also useful, such as are described in U.S. Pat. No. 4,001,184. Also, there can be utilized blends of linear polycarbonate and a branched polycarbonate. Moreover, blends of any of the above materials may be employed in the practice of this invention to provide the aromatic polycarbonate.

One aromatic carbonate is a homopolymer, e.g., a homopolymer derived from 2,2-bis(4-hydroxyphenyl)propane (bisphenol-A) and phosgene, commercially available under the trade designation LEXAN Registered TM from General Electric Company.

Branched polycarbonates are prepared by adding a branching agent during polymerization. These branching agents are well known and may comprise polyfunctional organic compounds containing at least three functional groups which may be hydroxyl, carboxyl, carboxylic anhydride, haloformyl and mixtures thereof. Specific examples include trimellitic acid, trimellitic anhydride, trimellitic trichloride, tris-p-hydroxy phenyl ethane, isatin-bis-phenol,tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid and benzophenone tetracarboxylic acid. The branching agent may be added at a level of about 0.05-2.0 weight percent. Branching agents and procedures for making branched polycarbonates are described in U.S. Letters Pat. Nos. 3,635,895; 4,001,184; and 4,204,047,which are incorporated by reference.

Additives—Other

The composition of the present invention may include additional components, which do not interfere with the previously mentioned desirable properties but enhance other favorable properties. These include, but are not limited to, antioxidants, lubricants, mold release agents, impact modifiers, flame retardants, fillers, colorants, nucleants or ultra violet (UV) or other radiation stabilizers.

Process and Levels of Materials

Process

The method of blending the compositions can be carried out by conventional techniques. One convenient method comprises blending the polyester or polycarbonate and other ingredients in powder or granular form, extruding the blend and comminuting into pellets or other suitable shapes. The ingredients are combined in any usual manner, e.g., by dry mixing or by mixing in the melted state in an extruder, on a heated mill or in other mixers. The treatment processes to react either the starting polyester and the acid enhancing group or the modified polyester and the reactive moiety can be any thermal or similar energetic manner that produces the desired reaction between the reactive additive and the polymer to produce the desired effect. Examples of typical thermal treatment processes used in the art include, but are not limited to melt mixing, melt extrusion, oven aging, solid-state polymerization, reactive injection molding, etc. Colorants or other additives may be added at any point during the treatment processes.

The resins and blends of this invention can be processed by various techniques including injection molding, blow molding, extrusion into sheet, film or profiles, compression molding and etc. They can also be formed into a variety of articles for use in, for example electrical connectors, electrical devices, computers, building and construction, outdoor equipment, trucks and automobiles.

Level of Materials

With respect to quantities of materials, the acid end group enhancing additive used is from about 0.1 weight percent to about 2.0 weight percent of the polyester, preferably about 0.2 weight percent to 1.0 weight percent of the polyester. The polyfunctional carboxy reactive material used for treating the modified polyester is from about 0.1 weight percent to about 30 weight percent of the modified polyester, preferably from about 0.2 to about 10 weight percent of the modified polyester. The final polyester is from about 10 weight percent of the total resin in the composition to 100 weight percent, preferably a minimum of about 15 weight percent of the total resin. Polycarbonate can be present in the composition up to about 90 weight percent of the total resins in the composition, preferably from about 40 weight percent to about 80 weight percent.

### EXAMPLES

From the granulate, the melt volume rate (MVR) was measured according to ISO 1133 (265° C./2.16 kg, unless otherwise stated) in units of cm³/10 min. The size of the orifice used was 0.0825″ diameter and the sample was dried at 100° C. for 60 minutes

Tensile Properties: The testing procedure follows the ASTM D638 standard. The test is carried out on a Zwick 1474 (+HASY). This machine is equipped with an automatic handling system. Tensile bars of type I ASTM with width of 13 mm and thickness of 3.2 mm were used.

Chemical Resistance Testing: Environmental Stress Cracking (ESCR) was used as a test to determine the performance of various compositions with respect to exposed chemicals. Details are outlined in ISO 4599 test method. The tensile bars are mounted on constant strain stainless steel jigs of 0.5% and 1%. The test was carried out at room temperature and the exposure time was forty-eight hours. The exposed samples are cleaned with soap and water before measuring their tensile retention by the method described above. Visual inspection and retention of tensile properties after exposure are used as criteria for comparison.

A polyester that shows the benefit of this invention is PCTG (80 mole % cyclohexane dimethanol, 20 mole % ethylene glycol). Table 1 illustrates the effect of terephthalic acid (TPA) addition to PCTG resin in an extrusion process versus water or dimethylterephthalate (DMT) addition. The melt viscosity rate (MVR) of the polyester increases, indicative of increasing end groups. Sample G in Table 1 is an example of the current invention and samples A to F are comparative examples.

The polyester used in Table 1 and the polycarbonate polyester compositions of Table 2 were extruded on a 40 mm twin-screw extruder with a feed rate of 320-lbs/hr and screw revolution per minutes (rpm) of 400. The extruder had seven heating zones and a separate die head heating zone. The first heating zone from the feeder side was kept at 100° F. and all other heating zones were set at 500° F. The die head heating zone was kept at 520° F. The compounding was done in two passes where the polyester was blended with the acid enhancing additive in the first pass. This blend was fed to the extruder from a hopper into first heating zone. This modified polyester was blended with the polycarbonate and the material with multiple epoxy groups such as Joncryl® ADR4368 and extruded in a similar manner described above. According to formulations shown in Table 2, Sample 8 is an example of current invention. Samples 1 to 7 are for comparison purposes only. If desired, the acid enhancing additive and the polyfunctional carboxy reactive material can be added simultaneously. If this is done, they can be added to the master blend containing the polycarbonate and the polyester. In case of a stepwise addition, the acid enhancing additive is added with the master blend containing polycarbonate and the polyester. Thereafter, the polyfunctional carboxy reactive material is added downstream, preferably in the fifth zone from the feeder side.

Reactive extrusion using terephthalic acid (TPA) and a polyester such as PCTG has shown surprisingly high reactivity, as measured by the MVR and therefore can be used to increase acid end- groups in polyester for its subsequent reaction with the material with multiple epoxy groups. TPA is found to be very effective in generating the acid end groups as shown by the maximum increase in the MVR value in Table 1. The polyester modified with TPA also has maximum reactivity towards epoxy groups when the polycarbonate polyester blends are made, as shown by the maximum reduction in MVR in Table 3 for sample 8. This reduced MVR is indicative of increased reactivity of the material with multiple epoxy groups towards the modified polyester.

It should be noted that hydrolysis of the polyester with water can also result in an increased number of acid end groups. However, as shown by data in Table 3, samples 3 to 6 that use polyester treated with water does not result in any improved melt viscosity when compared to sample 2 which uses the polyester that has not been treated with any additive. All samples 2 to 6 were reacted with the material with multi epoxy groups, Joncryl® ADR4368.

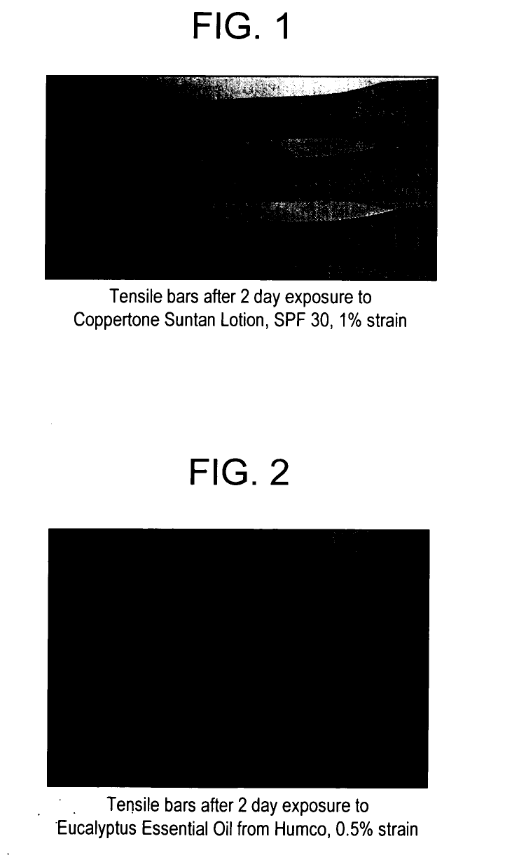

When polycarbonate-polyester blends are made using these modified polyesters in the presence of a material with multiple epoxy groups, the blends exhibit enhanced chemical resistance. This is illustrated by a marked improvement in retention of elongation on exposure to chemicals commonly used in the household. Results are summarized in Table 4(a) and (b). FIG. 1 & 2 show an improvement of invention blends with respect to visual appearance after chemical exposure. As shown in the FIGS. 1 & 2; Sample 8, which is an example of current invention, visually shows substantially improved resistance to exposed chemicals as compared to comparative samples 1 and 2.

TABLE 1

| Sample # | PCTG Kind | mvr* |
|---|---|---|
| A | As Received from Eastman | 17.0 |
| B | Pass one time through extruder with H2O(0.5%) | 19.5 |
| C | Pass two time through extruder with H2O(0.5%) | 21.8 |
| D | Pass three time through extruder with H2O(0.5%) | 24.2 |
| E | Pass four time through extruder with H2O(0.5%) | 26.4 |
| F | Pass one time through extruder with DMT(0.5%) | 19.4 |
| G | Pass one time through extruder with TPA(0.5%) | 31.4 |

*at 265 C. 2.16 kg load, 4 min Dwell

TABLE 2
Formulation [%]

| | Sample 1 | Sample 2 | Sample 3 | Sample 4 | Sample 5 | Sample 6 | Sample 7 | Sample 8 |
|---|---|---|---|---|---|---|---|---|
| LEXAN ML8199-111N | 36.4 | 36.2 | 36.2 | 36.2 | 36.2 | 36.2 | 36.2 | 36.2 |
| LEXAN 101-111N | 36.4 | 36.2 | 36.2 | 36.2 | 36.2 | 36.2 | 36.2 | 36.2 |
| PCTG, 80% CHDM | 26.3 | 26.3 | 26.3 | 26.3 | 26.3 | 26.3 | 26.3 | 26.3 |
| PCTG Kind, from TABLE 1 | A | A | B | C | D | E | F | G |
| Pentaerythritol tetrastearate | 0.30 | 0.30 | 0.30 | 0.30 | 0.30 | 0.30 | 0.30 | 0.30 |
| PEP-Q | 0.10 | 0.10 | 0.10 | 0.10 | 0.10 | 0.10 | 0.10 | 0.10 |
| Phosphoric Acid pre-diluted to 10% | 0.075 | 0.05 | 0.05 | 0.05 | 0.05 | 0.05 | 0.05 | 0.05 |
| Anti-oxidant 1010 | 0.12 | 0.12 | 0.12 | 0.12 | 0.12 | 0.12 | 0.12 | 0.12 |
| Joncryl ADR4368 | 0.00 | 1.00 | 1.00 | 1.00 | 1.00 | 1.00 | 1.00 | 1.00 |
| Total | 100 | 100 | 100 | 100 | 100 | 100 | 100 | 100 |

TABLE 3

| Sample # | mvr * |
|---|---|
| 1 | 12.0 |
| 2 | 7.2 |
| 3 | 6.9 |
| 4 | 7.1 |
| 5 | 6.9 |
| 6 | 7.2 |
| 7 | 7.2 |
| 8 | 5.8 |

* at 265 C. 2.16 kg load, 4 min dwell

TABLE 4(a)
Percent Retention of Elongation @ Break

| | Sample 1 | | Sample 2 | | Sample 8 | |
|---|---|---|---|---|---|---|
| Strain Level:- | 0.5% | 1.0% | 0.5% | 1.0% | 0.5% | 1.0% |
| Windex cleaner | 79 | All Bars Break | 69 | 3 | 101 | 5 |
| Cascade Solution (15 mL/L) | 86 | All Bars Break | 98 | 3 Bars Break | 102 | 90 |
| Coppertone(SPF 30) | 57 | All Bars Break | 63 | 2 | 86 | 3 |
| Vegetable Oil (Crisco) | 73 | All Bars Break | 59 | 4 | 70 | 4 |
| Eucalyptus essential oil (Humco) | All Bars Break | All Bars Break | 1 | All Bars Break | 2 | All Bars Break |
| WD40 cleaner | 73 | 15 | 65 | 49 | 104 | 54 |

TABLE 4(b)
Percent Retention in Tensile Stress @ Yield

| | Sample 1 | | Sample 2 | | Sample 8 | |
|---|---|---|---|---|---|---|
| Strain Level:- | 0.5% | 1.0% | 0.5% | 1.0% | 0.5% | 1.0% |
| Windex cleaner | 92 | All Bars Break | 96 | 84 | 98 | 83 |
| Cascade Solution (15 mL/L) | 92 | All Bars Break | 94 | 3 Bars Break | 98 | 96 |
| Coppertone(SPF 30) | 92 | All Bars Break | 97 | 60 | 89 | 96 |
| Vegetable Oil (Crisco) | 93 | All Bars Break | 97 | 93 | 100 | 94 |
| Eucalyptus essential oil (Humco) | All Bars Break | All Bars Break | 43 | All Bars Break | 34 | All Bars Break |
| WD40 cleaner | 94 | 94 | 97 | 96 | 100 | 100 |

1. A polyester resin composition comprising a modified polyester having increased acid end groups, the said modified polyester chemically reacted with a polyfunctional carboxy reactive material, the resulting polyester having enhanced chemical resistance and/or improved melt viscosity.

2. A process for producing a chemically resistant and /or enhanced melt viscosity polyester composition comprising treating a polyester resin having acid end groups with an acid enhancing additive thereby producing a modified polyester resin having an increased number of acid end groups, and chemically reacting a polyfunctional carboxy reactive material with at least a portion of the acid end groups of the modified polyester thereby increasing the chemical resistance and/or improving melt viscosity of the resulting polyester.

3. A polycarbonate polyester resin molding composition comprising a blend of a polycarbonate resin and a polyester resin having acid end groups, wherein said polyester resin has been treated with an acid enhancing additive thereby producing a modified polyester resin having an increased number of acid end groups.

4. A polycarbonate polyester resin molding composition of claim 3 wherein said modified polyester resin having an increased number of acid end groups is treated with a polyfunctional carboxy reactive material thereby enhancing the chemical resistance and/or improving melt viscosity of said polycarbonate/ polyester resin blend.

5. A process for producing a polycarbonate polyester resin molding composition having enhanced chemical resistance and/or improved melt viscosity comprising mixing polycarbonate resin, a polyester resin having acid end groups, and a polyfunctional carboxy reactive material and treating the said polyester resin with an acid enhancing additive either prior to or concomitantly with treating with the polyfunctional carboxy reactive material, thereby producing a modified polyester resin having an increased number of acid end groups.

6. A polyester resin modified to increase the acid end groups of the polyester resin.

7. A polyester resin of enhanced acid end group content that is reacted with polyfunctional carboxy reactive material to produce polyester containing materials of enhanced performance.

8. A process for chemically modifying the acid end group content of a polyester polymer in an extruder and subsequently reacting that modified polymer in an extruder to produce materials with enhanced performance such as improved chemical resistance and/or improved melt viscosity.

9. The composition in accordance with claim 1 wherein the polyfunctional carboxy reactive material is a material with multiple epoxy groups.

10. The process in accordance with claim 2 wherein the polyfunctional carboxy reactive material is a material with multiple epoxy groups.

11. The composition in accordance with claim 4 wherein the polyfunctional carboxy reactive material is a material with multi epoxy groups.

12. The process in accordance with claim 5 wherein the polyfunctional carboxy reactive material is a material with multi epoxy groups.

13. The composition in accordance with claim 7 wherein the polyfunctional carboxy reactive material is a material with multi epoxy groups.

14. The composition in accordance with claim 1 wherein the polyfunctional carboxy reactive material has a single epoxy group and at least one other acid reactive group.

15. The composition in accordance with claim 14 wherein the said one other acid reactive group is a silicone.

16. The composition in accordance with claim 1 wherein the polyfunctional carboxy reactive material has at least two epoxy groups.

17. A polyester resin composition comprising modified polyester having increased acid end groups chemically reacted with an epoxy material for enhancing the chemical resistance of the resulting polyester.
